(19) United States
(12) Patent Application Publication
(10) Pub. No.: US 2011/0232503 A1
(43) Pub. Date: Sep. 29, 2011

(54) GRILLING PLATE

(76) Inventor: Kun-Li Tsai, Shengang Township (TW)

(21) Appl. No.: 13/052,110

(22) Filed: Mar. 21, 2011

(30) Foreign Application Priority Data
Mar. 25, 2010 (TW) 099205262

(51) Int. Cl. A47J 37/07

(52) U.S. Cl. 99/450

(57) ABSTRACT

A grilling plate has two main tubular members, two connecting rods and a plurality of supporting rods. Each connecting rod is respectively attached onto and through each end of two main tubular members and can be tightened by corresponding securing nuts. Both ends of each supporting rod are respectively and evenly connected to both main tubular members.

### BACKGROUND OF THE INVENTION

1. Field of the Invention

The present invention relates to an improved grilling plate, and more particularly to a grilling plate that offers improved strength and that is easy to assemble.

2. Description of the Related Art

Barbequing is a very popular cooking method, and there are various grilling tools on the market.

As shown in FIG. 6, a prior art grilling plate 60 has a webbed structure with a plurality of apertures 61. The grilling plate 60 is placed over the grilling frame, and heat passes through the apertures 61.

However, the prior art structure has the following drawbacks: since the grilling plate 60 is a flat surface, it cannot be folded or broken into sections for carrying around. 2. The apertures 61 reduce the strength of the grilling plate 60, and in particular when food 70 is placed above the grilling plate 60 the grilling plate 60 tends to be bent by the weight of the food 70, as shown in FIG. 7. The deformation of the grilling plate 60 may cause uneven cooking temperatures for the food 70; also, the food 70 can come too close to the charcoal and become dirty. 3. Since the grilling plate 60 cannot be disassembled, it is very difficult to clean each aperture 61, such that most people tend to dispose of the grilling plate 60 which causes waste.

Therefore, it is desirable to provide an improved grilling plate to mitigate and/or obviate the aforementioned problems.

### SUMMARY OF THE INVENTION

An objective of the present invention is to provide an improved grilled plate providing stronger strength and easy assembling.

The grilling plate has at least two main tubular members, at least two connecting rods and a plurality of supporting rods. Each connecting rod is respectively attached onto and through each end of the two main tubular members and capable of being tightened by corresponding securing nuts. Both ends of each supporting rod are respectively and evenly connected to both main tubular members. Each main tubular member has a first diameter and an assembling aperture at each of two ends, each main tubular member has a plurality of through apertures between the two assembling apertures. Each connecting rod has a main section with a second diameter larger than a diameter of the assembling apertures, an outer threaded section with a smaller diameter respectively extends from at least the two ends of the main section such that the connecting rods are longer than the supporting rods.

With the above-mentioned embodiment, the following benefits can be obtained: 1. The main tubular members, the connecting rods and the supporting rods of the grilling plate 1 can all be individually disassembled for storage or transportation purposes. 2. Since the main tubular members, the connecting rod and the supporting rod of the grilling plate 1 can all be individually disassembled for cleaning purposes, the grilling plate 1 can be repeatedly used without being thrown away. 3. The main tubular members, the connecting rods and the supporting rods of the grilling plate 1 all provide stronger structural strength, therefore the weight of the food will not cause deformation and the food can be cooked evenly and without any contact with charcoal or ashes. 4. The user can manually disassemble the entire structure without needing any tools.

Other objects, advantages, and novel features of the invention will become more apparent from the following detailed description when taken in conjunction with the accompanying drawings.

### BRIEF DESCRIPTION OF THE DRAWINGS

FIG. 1 is a perspective assembly view of an embodiment of the present invention.

FIG. 2 is a perspective exploded view of the embodiment of the present invention.

FIG. 3 is a local detailed view of the embodiment of the present invention.

FIG. 4 is a schematic drawing of food moving onto the grilling plate of the embodiment of the present invention.

FIG. 5 is another schematic drawing of food moving onto the grilling plate of the embodiment of the present invention.

FIG. 6 is a perspective view of a prior art structure.

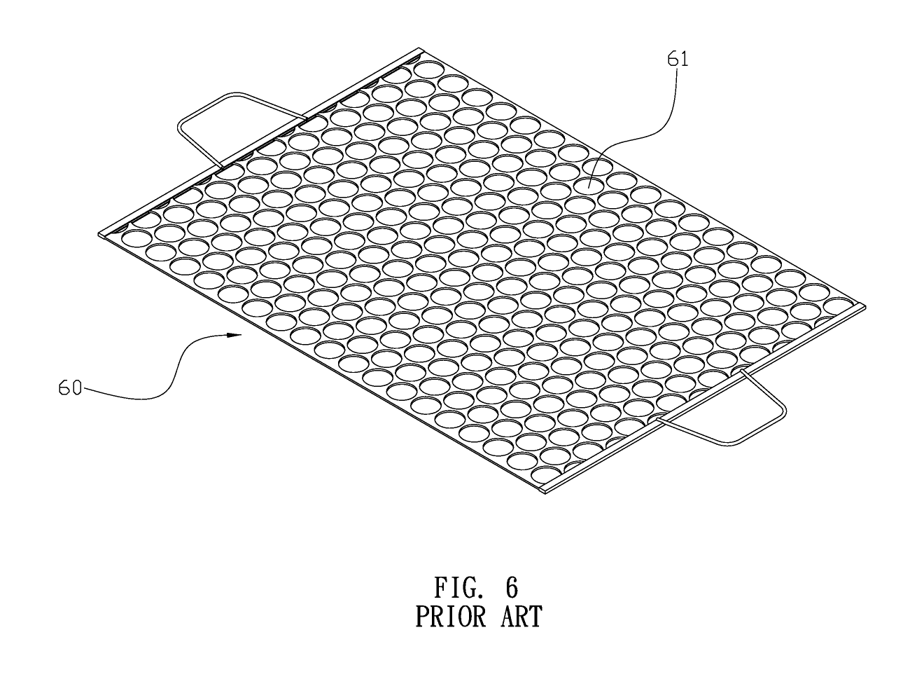

FIG. 7 is a schematic drawing showing the prior art structure being bent by food.

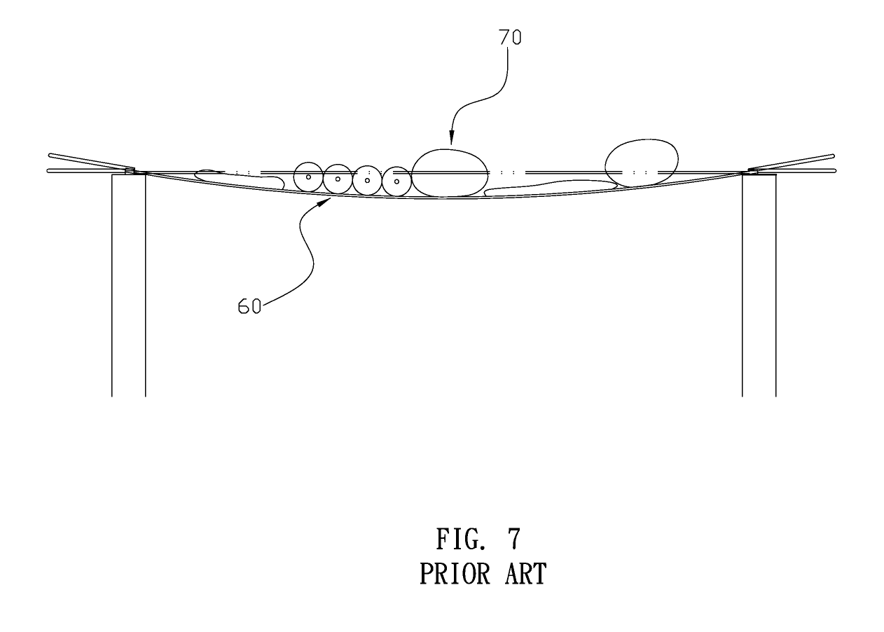

### DETAILED DESCRIPTION OF THE PREFERRED EMBODIMENT

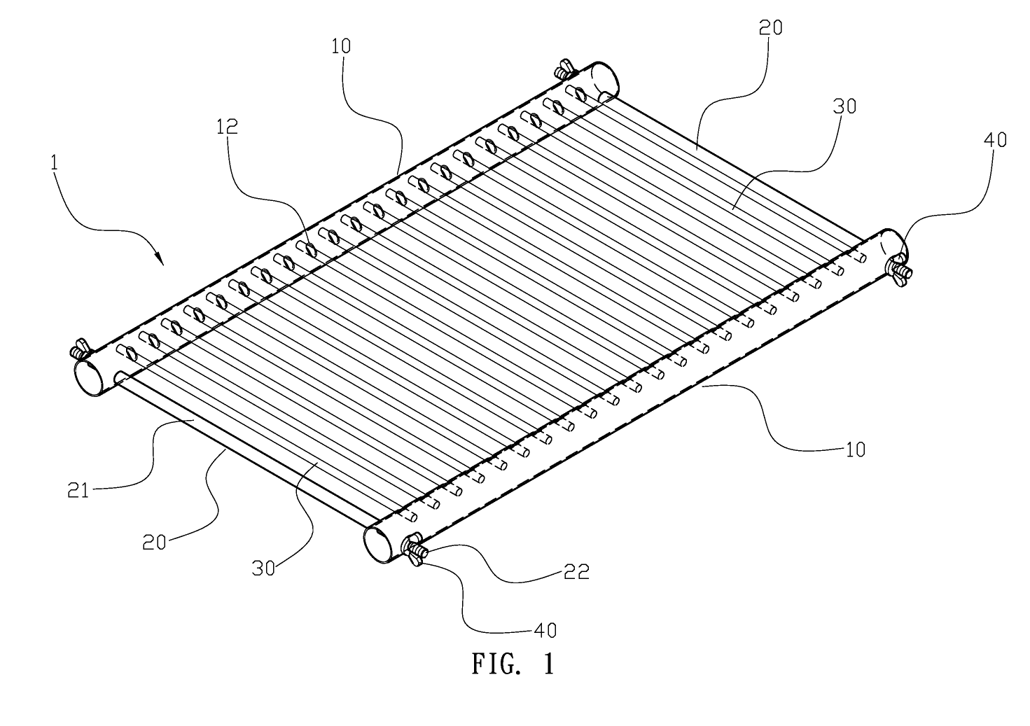

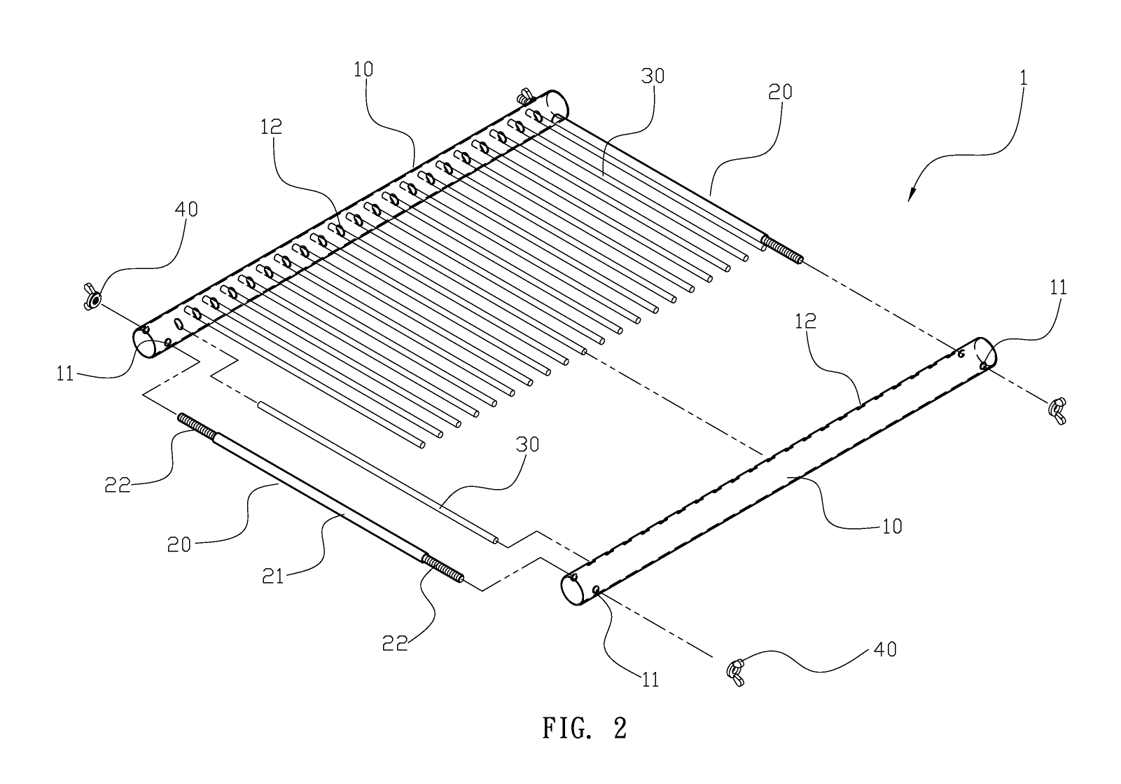

First, please refer to FIG. 1 and FIG. 2. A grilling plate 1 comprises two main tubular members 10, two connecting rods 20 and a plurality of supporting rods 30. Each connecting rod 20 is respectively attached onto and through each end of two main tubular members 10 and can be tightened by corresponding securing nuts 40. Both ends of each supporting rod 30 are respectively and evenly connected to both main tubular members 10. Each main tubular member 10 has a first diameter and an assembling aperture 11 at each of two ends, and each main tubular member 10 has a plurality of through apertures 12 between the two assembling apertures 11. Each connecting rod 20 has a main section 21 with a second diameter larger than a diameter of the assembling apertures 11, with an outer threaded section 22 having a smaller diameter respectively extending from the two ends of the main section 21 such that the connecting rods 20 are longer than the supporting rods 30.

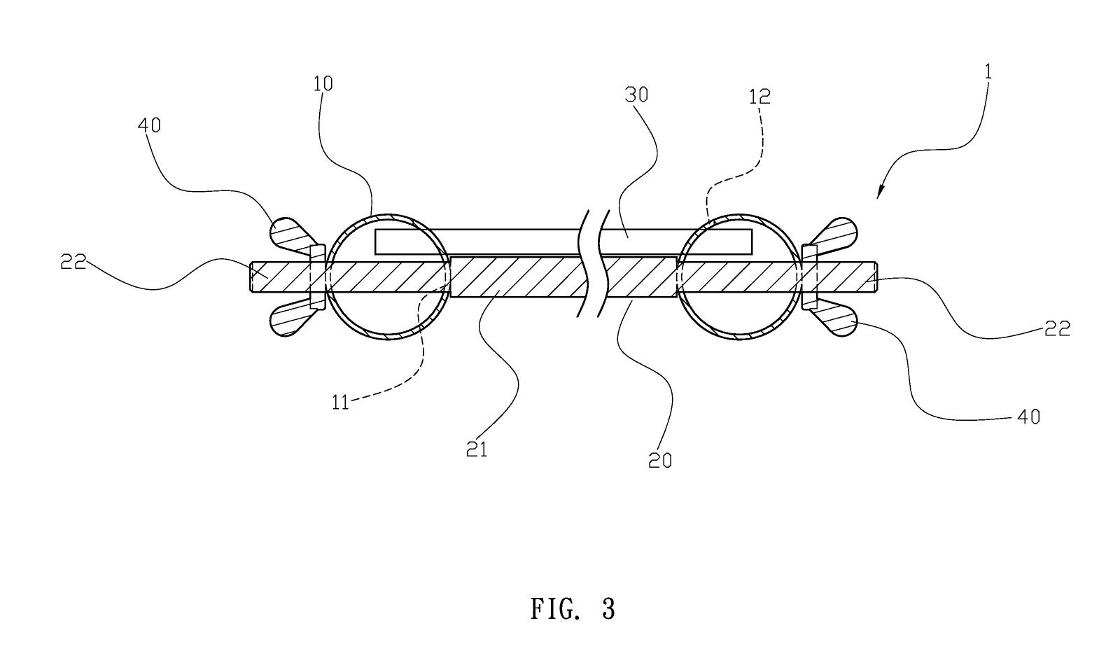

For actual assembly, please refer again to FIGS. 1-3. The two main tubular members 10 are placed parallel to each other. The assembling apertures 11 accept the outer threaded sections 22 of the connecting rods 20, and the through apertures 12 accept the supporting rods 30, such that the two main tubular members 10 sandwich the connecting rods 20 and the supporting rods 30. The outer threaded sections 22 extending from opposite sides of the two main tubular members 10 engage with the securing nuts 40. The securing nuts 40 and the main sections 21 of the connecting rods 20 are larger than the assembling apertures 11, the connecting rods 20 are positionally fixed so that they cannot undergo any movement. Since the connecting rods 20 are slightly longer than the supporting rods 30, the supporting rods 30 attached onto the main tubular members 10 have no contact with the inner sides of the main tubular members 10 and are pivoted onto main tubular members 10.

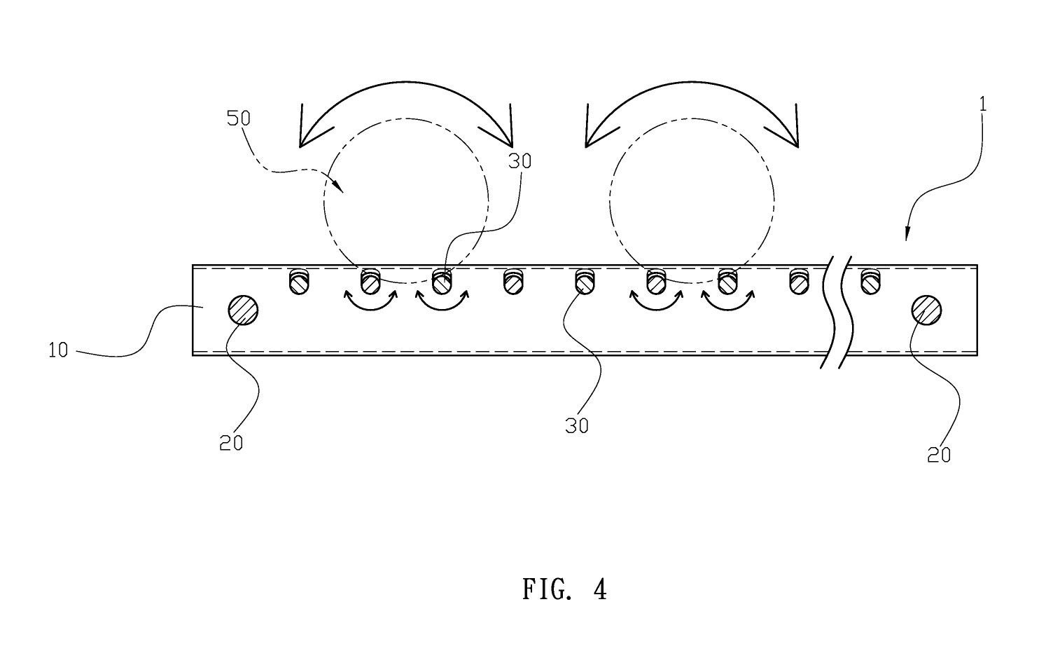

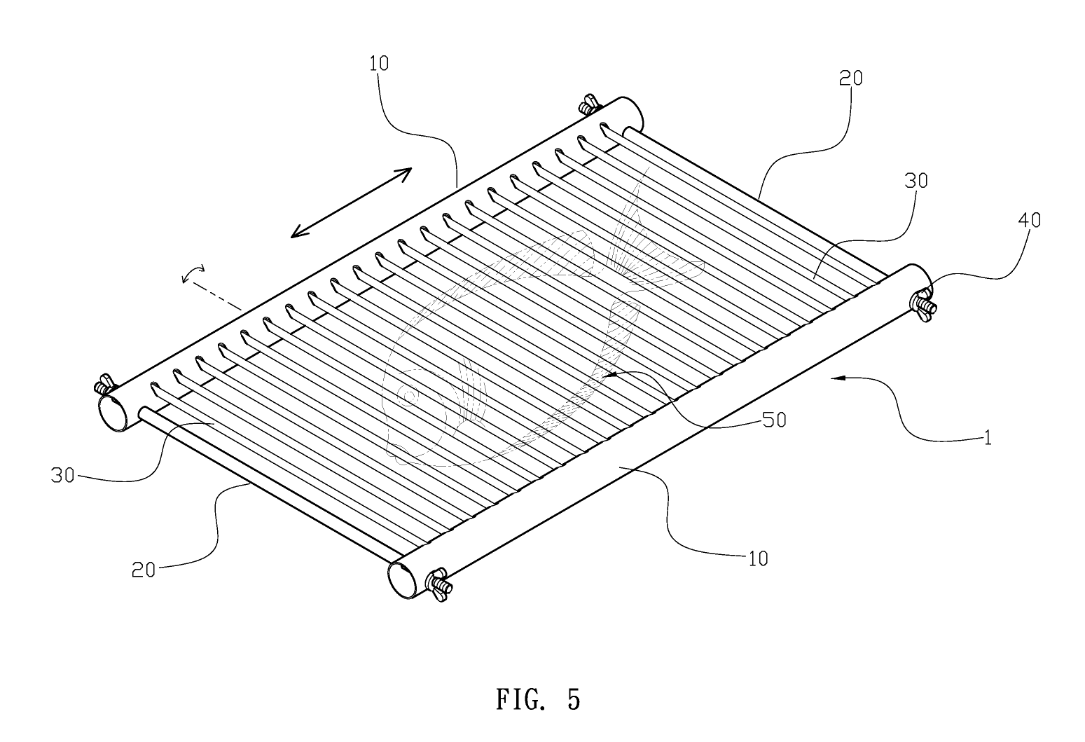

For actual usage, the grilling plate 1 is placed on a grilling stove or grilling stand, and the surface formed by the supporting rods 30 provides space for the food 50 to be cooked. Since the supporting rods 30 are pivoted onto the main tubular member 10, they can rotate randomly. During the cooking process, for food 50 having a relatively smaller contact surface, it can be rotated around on the supporting rods 30 for even heat conduction, as shown in FIG. 4. In addition, depending on the actual heat distribution, the food 50 can also be moved horizontally, as shown in FIG. 5. After the cooking process is finished, the securing member 40 can be loosened, such that the main tubular members 10, the connecting rods 20, and the supporting rods 30 can all be individually disassembled for cleaning or storage purposes.

The securing members 40 can be wing nuts, which allow the user to manually disassemble the grilling plate 10 without any tools.

With the above-mentioned embodiment, the following benefits can be obtained: 1. The main tubular members 10, the connecting rods 20 and the supporting rods 30 of the grilling plate 1 can all be individually disassembled for storage or transportation purposes. 2. Since the main tubular members 10, the connecting rod 20 and the supporting rod 30 of the grilling plate 1 can all be individually disassembled for cleaning purposes, the grilling plate 1 can be repeatedly used without being thrown away. 3. The main tubular members 10, the connecting rods 20 and the supporting rods 30 of the grilling plate 1 all provide stronger structural strength, therefore the weight of the food 50 will not cause deformation and the food 50 can be cooked evenly and without any contact with charcoal or ashes. 4. The user can manually disassemble the entire structure without needing any tools.

Although the present invention has been explained in relation to its preferred embodiment, it is to be understood that many other possible modifications and variations can be made without departing from the spirit and scope of the invention as hereinafter claimed.

What is claimed is:

1. A grilling plate comprising at least two main tubular members, at least two connecting rods and a plurality of supporting rods; each connecting rod respectively attached onto and through each end of the two main tubular members and capable of being tightened by corresponding securing nuts; and both ends of each supporting rod respectively and evenly connected to both main tubular members; wherein
each main tubular member has a first diameter and an assembling aperture at each of two ends, each main tubular member having a plurality of through apertures between the two assembling apertures; and
each connecting rod has a main section with a second diameter larger than a diameter of the assembling apertures, an outer threaded section with a smaller diameter respectively extending from at least the two ends of the main section such that the connecting rods are longer than the supporting rods;
wherein the at least two main tubular members are placed parallel to each other, the assembling apertures accept the outer threaded sections of the connecting rods, and the through apertures accept the supporting rods, such that the at least two main tubular members sandwich the connecting rods and the supporting rods; the outer threaded sections extending from opposite sides of the two main tubular members engaging with the securing nuts; wherein the securing members and the main sections of the connecting rods are larger than the assembling apertures, the connecting rods are positionally fixed; and since the connecting rod is longer than the supporting rod, the supporting rods attached onto the main tubular members have no contact with an inner side of the main tubular members and are pivoted onto main tubular members.

2. The grilling plate as claimed in claim 1 wherein the assembling apertures are aligned with a central axial line of the main tubular members, and all of the through apertures are disposed along a line adjacent to the assembling apertures on each main tubular member.

3. The grilling plate as claimed in claim 1 wherein the through apertures are circular apertures.

4. The grilling plate as claimed in claim 1 wherein the through apertures are oval apertures.

5. The grilling plate as claimed in claim 1 wherein the securing members are wing nuts.
